(19) United States
(12) Patent Application Publication
(10) Pub. No.: US 2010/0239867 A1
(43) Pub. Date: Sep. 23, 2010

(54) SEALING MATERIAL, PARTS FOR PLASMA TREATING EQUIPMENT HAVING SAID SEALING MATERIAL, AND PROCESS FOR PREPARING SAID SEALING MATERIAL

(75) Inventors: Soushi Tsuchiya, Settsu-shi (JP); Katsuhiko Higashino, Settsu-shi (JP); Yasuhiro Sakamoto, Settsu-shi (JP); Tsuyoshi Noguchi, Settsu-shi (JP)

Correspondence Address: SUGHRUE MION, PLLC, 2100 PENNSYLVANIA AVENUE, N.W., SUITE 800, WASHINGTON, DC, 20037, US

(73) Assignee: Daikin Industries, Ltd., Osaka-shi, Osaka (JP)

(21) Appl. No.: 12/305,795

(22) PCT Filed: Jun. 22, 2007
(86) PCT No.: PCT/JP2007/062574

§ 371 Date: Dec. 19, 2008

(30) Foreign Application Priority Data
Jun. 22, 2006 (JP) 2006-173138

(51) Int. Cl. B32B 27/06; B05D 1/18

(52) U.S. Cl. 428/422; 427/430.1

(57) ABSTRACT

The present invention provides a sealing material having excellent plasma resistance, sealing property and non-sticking property, parts for plasma treating equipment having the sealing material, and a process for preparing the sealing material. The sealing material comprises a fluoroelastomer sealing material and a coating film formed by using an inorganic material on the surface of the fluoroelastomer sealing material, wherein a ratio of weight reduction of the sealing material after dipping it in perfluoro tri-n-butylamine at 60° C. for 70 hours and then taking it out and drying it at 90° C. for 5 hours, at 125° C. for 5 hours, and then at 200° C. for 10 hours, is not more than 0.4% by weight.

### TECHNICAL FIELD

The present invention relates to a sealing material comprising a specific fluoroelastomer sealing material and a coating film of an inorganic material formed on the surface of the fluoroelastomer sealing material, to parts for plasma treating equipment having the sealing material, and to a process for preparing the sealing material.

### BACKGROUND ART

Fluorine-containing elastomers, particularly perfluoroelastomers mainly comprising a tetrafluoroethylene (TFE) unit are widely used as sealing materials in the fields of automobile industry, semiconductor industry and chemical industry because they exhibit excellent chemical resistance, solvent resistance and heat resistance.

In processes for preparing liquid crystal and semiconductors, treating equipment using plasma is used, and for such plasma treating equipment, elastomeric sealing materials are used on various connecting parts and moving parts for the purpose of sealing. These sealing materials are required not only to have sealing property but also to withstand harsh plasma treating conditions of high density (10¹² to 10¹³/cm³) due to ultra fine fabrication and large size substrate wafer and not to pollute semiconductors which need be subjected to extremely fine fabrication. For example, in etching and ashing steps in production of semiconductors, high density O₂ plasma and CF₄ plasma processes are executed. Accordingly, sealing materials are required to have resistance to plasmas in O₂ plasma treatment and CF₄ plasma treatment.

With respect to sealing materials satisfying such requirements, there is generally known a method of blending a filler having a plasma-shielding effect to an elastomer. However, even in such an elastomer material containing a filler, an elastomer is gradually deteriorated due to exposure to plasma, and the blended filler giving plasma resistance is released from the elastomer. The releasing of the filler leads to generation of particles, and results in lowering of plasma resistance of the elastomer material, which does not satisfy properties required for a long period of time. Also, there is disclosed a sealing material comprising a substrate prepared from a composition comprising a crosslinkable fluorine-containing elastomer and a coating film of diamond-like carbon formed on at least a part of the surface of the substrate for the purpose of improving plasma (oxygen) resistance and non-sticking property (for example, refer to JP2003-165970A). Further, there is disclosed a sealing material comprising a rubber substrate and a coating film of diamond-like carbon formed on the surface of the substrate for the purpose of improving non-sticking property and imparting sliding property (for example, refer to JP2002-47479A, JP2002-47480A and JP2002-48240A). However, these sealing materials have a problem that a component contained in the rubber material oozes out onto the coating film, resulting in lowering of non-sticking property and making plasma resistance inferior.

On the other hand, there is known a perfluoroelastomer sealing material containing not more than 1% by weight of un-crosslinked polymer component measured under specific conditions in order to decrease sticking strength and make improvement in preventing contamination, corrosion and discoloration of a surface coming into contact with the sealing material (for example, refer to WO 2005/028547). However, study is not made at all with respect to coating of a sealing material surface.

Also, there is known a sealing material for semiconductor manufacturing equipment, in which an amount of water generation after heating at 200° C. for 30 minutes is not more than 400 ppm (for example, refer to WO 2001/85848). However, study is not made at all with respect to coating of a sealing material surface.

### DISCLOSURE OF INVENTION

The present invention provides a sealing material having excellent plasma resistance, sealing property and non-sticking property, and parts for plasma treating equipment having the sealing material.

Namely, the present invention relates to a sealing material comprising a fluoroelastomer sealing material and a coating film formed by using an inorganic material on the surface of the fluoroelastomer sealing material, wherein a ratio of weight reduction of the sealing material after dipping it in perfluoro tri-n-butylamine at 60° C. for 70 hours and then taking it out and drying it at 90° C. for 5 hours, at 125° C. for 5 hours, and then at 200° C. for 10 hours, is not more than 0.4% by weight.

Also, the present invention relates to a sealing material comprising a fluoroelastomer sealing material and a coating film formed by using an inorganic material on the surface of the fluoroelastomer sealing material, wherein an amount of water generation from the sealing material by heating is not more than 400 ppm.

It is preferable that the coating film formed by using an inorganic material is a film of diamond-like carbon.

It is preferable that the fluoroelastomer is a perfluoroelastomer.

It is preferable that the sealing material is for plasma treating equipment.

In addition, the present invention relates to parts for plasma treating equipment having the above-mentioned sealing material.

Also, the present invention relates to a process for preparing a sealing material comprising forming a coating film by using an inorganic material on a surface of a fluoroelastomer sealing material, wherein a ratio of weight reduction of the fluoroelastomer sealing material after dipping it in perfluoro tri-n-butylamine at 60° C. for 70 hours and then taking it out and drying it at 90° C. for 5 hours, at 125° C. for 5 hours, and then at 200° C. for 10 hours, is not more than 0.4% by weight.

The present invention further relates to a process for preparing a sealing material comprising forming a coating film by using an inorganic material on a surface of a fluoroelastomer sealing material, wherein an amount of water generation from the fluoroelastomer sealing material by heating is not more than 400 ppm.

It should be noted that hereinafter, when referred to as “sealing material”, it means a sealing material having, on its surface, a coating film formed by using an inorganic material, and a fluoroelastomer sealing material to be provided with the coating film thereon is referred to as “fluoroelastomer sealing material”.

### BRIEF DESCRIPTION OF DRAWINGS

FIG. 1 An explanatory view showing a method of treating a test piece for measuring sticking strength.

FIG. 2 An explanatory view showing a method of measuring sticking strength.

### BEST MODE FOR CARRYING OUT THE INVENTION

The present invention relates to the sealing material comprising a fluoroelastomer sealing material and a coating film formed by using an inorganic material on the surface of the fluoroelastomer sealing material, wherein a ratio of weight reduction of the sealing material after dipping it in perfluoro tri-n-butylamine at 60° C. for 70 hours and then taking it out and drying it at 90° C. for 5 hours, at 125° C. for 5 hours, and then at 200° C. for 10 hours, is not more than 0.4% by weight. It is preferable that the fluoroelastomer sealing material has the coating film all over the surface thereof.

In the sealing material of the present invention, the ratio of weight reduction of the sealing material after dipping it in perfluoro tri-n-butylamine at 60° C. for 70 hours and then taking it out and drying it at 90° C. for 5 hours, at 125° C. for 5 hours, and then at 200° C. for 10 hours, is more preferably not more than 0.4% by weight, further preferably not more than 0.3% by weight, especially preferably not more than 0.1% by weight. The lower the weight reduction ratio is, the better it is. The lower limit is not limited particularly. When the weight reduction ratio is higher, there is a tendency that the components contained in the fluoroelastomer sealing material oozes out from the fluoroelastomer sealing material onto the coating film, further outside the sealing material, thereby lowering non-sticking property and making plasma resistance inferior. The weight reduction of the sealing material results from elution of un-crosslinked polymer and low molecular weight substance contained in the fluoroelastomer sealing material into perfluoro tri-n-butylamine. The un-crosslinked polymer is a polymer which has not been crosslinked when molding the fluoroelastomer sealing material or a polymer of which crosslinking has been cut. The low molecular weight substance is one remaining after the polymerization, one which has not been sufficiently crosslinked when molding the fluoroelastomer sealing material or one resulting from cutting of a molecular chain of a high molecular weight substance due to a stress applied during processing when molding the fluoroelastomer sealing material or due to heating at secondary vulcanization. The low molecular weight substance is one having a number average molecular weight of not more than 10,000.

The weight reduction ratio of the sealing material is determined by:

(1) measuring a weight (Ag) of the untreated sealing material,
(2) dipping the sealing material in perfluoro tri-n-butylamine at 60° C. for 70 hours and then taking it out and drying it at 90° C. for 5 hours, at 125° C. for 5 hours, and then at 200° C. for 10 hours, and
(3) measuring a weight (Bg) of the dried sealing material. The weight reduction ratio of the sealing material is calculated by {(A−B)/A}×100 (% by weight).

The reason why perfluoro tri-n-butylamine is used as an extractant for measuring a weight reduction ratio is that every kind of fluoroelastomer can swell sufficiently in perfluoro tri-n-butylamine.

Here the weight reduction ratio of the sealing material of not more than 0.4% by weight means the weight reduction ratio of the sealing material itself. Since the coating film itself formed by using an inorganic material is not subject to weight reduction even if treated with perfluoro tri-n-butylamine, the weight reduction is one caused by weight reduction of the fluoroelastomer sealing material constituting the sealing material.

According to the present invention, the fluoroelastomer sealing material is more preferably one where the ratio of weight reduction of the sealing material after dipping it in perfluoro tri-n-butylamine at 60° C. for 70 hours and then taking it out and drying it at 90° C. for 5 hours, at 125° C. for 5 hours, and then at 200° C. for 10 hours, is not more than 0.4% by weight, further preferably not more than 0.3% by weight, especially preferably not more than 0.1% by weight. The lower the weight reduction ratio is, the better it is. The lower limit is not limited particularly.

The weight reduction ratio of the fluoroelastomer sealing material is determined by:

(1) measuring a weight (Ag) of the untreated fluoroelastomer sealing material,
(2) dipping the fluoroelastomer sealing material in perfluoro tri-n-butylamine at 60° C. for 70 hours and then taking it out and drying it at 90° C. for 5 hours, at 125° C. for 5 hours, and at 200° C. for 10 hours, and
(3) measuring a weight (Bg) of the dried fluoroelastomer sealing material.
The weight reduction ratio of the fluoroelastomer sealing material is calculated by {(A−B)/A}×100 (% by weight).

In the fluoroelastomer sealing material of the sealing material of the present invention, the ratio of weight reduction of the sealing material after dipping it in perfluoro tri-n-butylamine at 60° C. for 70 hours and then taking it out and drying at 90° C. for 5 hours, at 125° C. for 5 hours, and then at 200° C. for 10 hours, is not more than 0.4% by weight, and a process for preparing the fluoroelastomer sealing material is not limited particularly. For example, it is preferable to prepare by a preparation process including a step for treating the molded fluoroelastomer sealing material with a solvent giving a swelling ratio of the fluoroelastomer sealing material of not less than 50% when dipping it at 60° C. for 70 hours.

Here the “swelling ratio” of the sealing material is determined by:

(1) heat-treating in the air at 300° C. for 70 hours,
(2) then measuring a volume (C1) of the fluoroelastomer sealing material by a method of substitution in water,
(3) dipping the sealing material in the solvent (perfluoro tri-n-butylamine) at 60° C. for 70 hours,
(4) after taking out the swollen sealing material, measuring its volume (D1), and
(5) calculating by (D1−C1)/C1×100(%).

The solvent to be used for the treatment is a single use of a solvent giving a swelling ratio of not less than 50% when dipping at 60° C. for 70 hours or a mixture of two or more kinds of such a solvent, and the swelling ratio is more preferably not less than 80%. When the swelling ratio is less than 50%, there is a tendency that it takes much time to extract a low molecular weight substance and an un-crosslinked polymer.

In addition, from the view point that the above-mentioned function and effect can be exhibited more, it is preferable that the solvent to be used for the treatment is a single use of a solvent giving a swelling ratio of not less than 50% when dipping at 40° C. (a boiling point of the solvent when it is lower than 40° C.) for 70 hours or a mixture of two or more kinds of such a solvent, and the swelling ratio is more preferably not less than 80%.

Preferable as the above-mentioned solvent are perhalo-type solvents in which all of hydrogen atoms are substituted with halogen atoms. Especially preferable are perfluoro-type solvents in which all of hydrogen atoms are substituted with fluorine atoms and perchlorofluoro-type solvents in which all of hydrogen atoms are substituted with fluorine atoms and chlorine atoms. Examples of perfluoro-type solvents are perfluoroalkane; perfluoro tri-amines such as perfluoro tri-n-butylamine and perfluoro triethylamine; perfluoro substituted tetrahydrofuran, perfluorobenzene, FLORINATE FC-77 (available from Sumitomo 3M Limited, principal component: C₈F₁₆O), DEMNUM solvent (available from Daikin Industries, Ltd., principal component: C₆F₁₄), FLORINATE FC-43 (available from Sumitomo 3M Limited, principal component: (C₄F₉)₃N), and the like. Examples of perchlorofluoro-type solvents are, for instance, R-318 (available from Daikin Industries, Ltd., principal component: C₄F₈Cl₂), and the like. Among these, perfluoro tri-n-butylamine, FLORINATE FC-77 and R-318 are preferable from the viewpoint of easy handling.

Other solvents to be used for the treatment are those satisfying the above-mentioned conditions, and, for example, various fluorine-containing solvents other than those mentioned above are used preferably. Examples thereof are HFC (hydrofluorocarbon), HFE (hydrofluoroether), HCFC (hydrochlorofluorocarbon), and the like, and there are concretely HFE-7100 (available from Sumitomo 3M Limited, principal component: C₄F₉OCH₃), HFE-7200 (available from Sumitomo 3M Limited, principal component: C₄F₉OC₂H₅), Vertrel XF (available from Du Pont, principal component: C₅H₂F₁₀), and the like.

Examples of a method of treating the fluoroelastomer sealing material are a method of dipping in the above-mentioned solvent, a method of exposure to vapor of the above-mentioned solvent, a method of atomizing the above-mentioned solvent, a method of extracting by Soxhlet extraction or similar extraction means with the above-mentioned solvent, a supercritical extraction method, and the like. In the supercritical extraction method, by using the above-mentioned solvent as an entrainer, even in the case of using carbon dioxide gas as an extraction medium, a low molecular weight substance and an un-crosslinked polymer can be extracted efficiently.

In the case where the fluoroelastomer sealing material is dipped in the above-mentioned solvent, dipping conditions may be optionally decided depending on kind of a solvent to be used, composition of the fluoroelastomer, etc., and preferable condition is dipping at room temperature to 250° C. for 1 to 100 hours. More preferable is dipping at room temperature to 200° C., further preferably at room temperature to 100° C. for 48 to 70 hours. Further, it is preferable to treat under high pressure.

After the dipping or the atomizing, drying is carried out. The drying conditions are preferably drying at 250° C. or lower for five hours or more, more preferably drying at 200° C. for ten hours or more. For the drying, drying methods generally used such as drying in an oven and vacuum drying can be employed.

It can be considered that by the treatment using the above-mentioned solvent, swelling of the fluoroelastomer sealing material occurs, and a low molecular weight substance and an un-crosslinked polymer are dissolved into the solvent through a clearance generated due to the swelling.

Also, the present invention relates to the sealing material comprising a fluoroelastomer sealing material and a coating film formed by using an inorganic material on the surface of the fluoroelastomer sealing material, wherein an amount of water generation from the sealing material by heating is not more than 400 ppm. It is preferable that the coating film is formed all over the surface of the fluoroelastomer sealing material.

In the sealing material of the present invention, the amount of water generation from the sealing material by heating is not more than 400 ppm, preferably not more than 300 ppm. When the amount of water generation is larger than 400 ppm, the water oozes out onto the coating film, thereby lowering non-sticking property and making plasma resistance inferior. The amount of water generation is obtained by measuring, with Karl Fischer equipment, an amount of water generation to be generated when heating the sealing material at 200° C. for 30 minutes. Since an actual amount of water generation varies depending on a weight of O-ring to be used, a value (ppm) obtained by dividing a water amount (μg) actually measured using the O-ring by a weight of the O-ring is used. For example, when an O-ring (P24 size) sample having a weight of 1.7 g is used, since 1 μg/g is equal to 1 ppm, 400 ppm indicates that 680 μg of water is generated from the 1.7 g O-ring.

In addition, an amount of organic gas generation by heating is preferably not more than 0.03 ppm, more preferably not more than 0.02 ppm. When the amount of organic gas generation is larger, the generated gas components ooze out onto the coating film, thereby in some cases, lowering non-sticking property and making plasma resistance inferior. The amount of organic gas generation by heating is a value obtained by analyzing, with purge and trap type gas chromatograph, gas components generated when heating the sealing material at 200° C. for 15 minutes. An actual amount of organic gas generation is a value (ppm) obtained by dividing an organic gas amount (μg) measured using the O-ring by a weight of the sample O-ring in the same manner as in the above-mentioned amount of water generation.

The amount of water generation and the amount of organic gas generation of the sealing material mean amounts of water and gas generation from the sealing material itself, and since water and organic gas are not generated from the coating film formed by using an inorganic material, the amounts are derived from the fluoroelastomer sealing material constituting the sealing material.

Accordingly, in the present invention, the amount of water generation from the fluoroelastomer sealing material is preferably not more than 400 ppm, more preferably not more than 300 ppm. This amount of water generation can be obtained in the same manner as in the above-mentioned sealing material.

A process for preparing the fluoroelastomer sealing material of which water generation by heating is not more than 400 ppm is not limited particularly, and there is, for example, a process for heat-treating a press-crosslinked molded article at 150° to 230° C. for 4 to 30 hours in a stream of inert gas such as nitrogen gas. When the heating temperature is lower than 150° C., there is a tendency that heat-treating time becomes longer and productivity becomes inferior, and when higher than 230° C., the fluoroelastomer sealing material tends to be deteriorated.

It is preferable to carry out washing before the heat treatment to remove oil, foreign matter and metallic components sticking on the surface of the fluoroelastomer sealing material and not to lower interfacial adhesion between the fluoroelastomer sealing material and the coating film. Examples of a washing liquid to be used for the washing are sulfuric acid/hydrogen peroxide, hydrofluoric acid, ultra pure water, etc. These washing liquids can be heated before use.

In the present invention, fluoroelastomers which have been used for sealing materials, especially sealing materials for semiconductor manufacturing equipment can be used suitably without limitation. There are exemplified non-perfluoroelastomers and perfluoroelastomers, and especially in the case of the use for plasma generating equipment, perfluoroelastomers are preferable from the viewpoint of chemical resistance, heat resistance and resistance to various plasmas. Perfluoroelastomer means an elastomer comprising not less than 90% by mole of perfluoroolefin based on constituting units.

Examples of non-perfluoroelastomer are vinylidene fluoride (hereinafter referred to as VdF) type fluorine-containing rubber, tetrafluoroethylene (hereinafter referred to as TFE)/propylene type fluorine-containing rubber, TFE/propylene/VdF type fluorine-containing rubber, ethylene/hexafluoropropylene (hereinafter referred to as HFP) type fluorine-containing rubber, ethylene/HFP/VdF type fluorine-containing rubber, ethylene/HFP/TFE type fluorine-containing rubber, fluorosilicone type fluorine-containing rubber, fluorophosphazene type fluorine-containing rubber, and the like. These can be used alone or can be used in an optional combination thereof to an effect not to impair the effect of the present invention.

The VdF type fluorine-containing rubber means a fluorine-containing copolymer comprising 45 to 85% by mole of VdF and 55 to 15% by mole of at least one kind of other monomer being copolymerizable with VdF, preferably a fluorine-containing copolymer comprising 50 to 80% by mole of VdF and 50 to 20% by mole of at least one kind of other monomer being copolymerizable with VdF.

Examples of the at least one kind of other monomer being copolymerizable with VdF are, for instance, fluorine-containing monomers such as TFE, chlorotrifluoroethylene (hereinafter referred to as CTFE), trifluoroethylene, HFP, trifluoropropylene, tetrafluoropropylene, pentafluoropropylene, trifluorobutene, tetrafluoroisobutene, perfluoro(alkyl vinyl ether) (hereinafter referred to as PAVE) and vinyl fluoride, and non-fluorine-containing monomers such as ethylene, propylene and alkyl vinyl ether. These can be used alone or can be used in an optional combination thereof. Among these, TFE, HFP and PAVE are preferable.

Examples of such a VdF type fluorine-containing rubber are a VdF/HFP type rubber, a VdF/HFP/TFE type rubber, a VdF/CTFE type rubber, a VdF/CTFE/TFE type rubber, and the like.

The TFE/propylene type fluorine-containing rubber means a fluorine-containing copolymer comprising 45 to 70% by mole of TFE, 55 to 30% by mole of propylene and 0 to 5% by mole of a monomer giving a cure site based on the total amount of TFE and propylene.

Examples of the monomer giving a cure site are iodine-containing monomers such as perfluoro(6,6-dihydro-6-iodo-3-oxa-1-hexene) and perfluoro(5-iodo-3-oxa-1-pentene) disclosed in JP5-63482B and JP7-316234A, bromine-containing monomers disclosed in JP4-505341A, cyano-containing monomers, carboxyl-containing monomers and alkoxycarbonyl-containing monomers disclosed in JP4-505345A and JP5-500070A, and the like.

These non-perfluoroelastomers can be prepared by usual processes.

Examples of the perfluoroelastomer are those comprising TFE, PAVE and a monomer giving a cure site. The proportion of TFE/PAVE is preferably 50 to 90/10 to 50% by mole, more preferably 50 to 80/20 to 50% by mole, further preferably 55 to 70/30 to 45% by mole. It is preferable that the amount of monomer giving a cure site is preferably 0 to 5% by mole, more preferably 0 to 2% by mole based on the total amount of TFE and PAVE. If the proportions thereof are beyond the above-mentioned ranges, there is a tendency that properties of elastic rubber are lost and the rubber comes to have properties close to those of a resin.

Examples of the PAVE are, for instance, perfluoro(methyl vinyl ether), perfluoro(ethyl vinyl ether), perfluoro(propyl vinyl ether), perfluoro(butyl vinyl ether), and the like, which can be used alone or can be used in an optional combination thereof.

Examples of the monomer giving a cure site are iodine- or bromine-containing monomers represented by the general formula (1):

CX¹₂═CX¹—R_{f}¹CHR¹X² (1)

wherein X¹ is hydrogen atom, a fluorine atom or —CH₃; R¹ is hydrogen atom or —CH₃; X² is an iodine atom or a bromine atom; R_{f}¹ is a fluoroalkylene group, a perfluoroalkylene group, a fluoropolyoxyalkylene group or a perfluoropolyoxyalkylene group and may have an ether-bonding oxygen atom, and monomers represented by the general formula (2):

CF₂═CFO(CF₂CF(CF₃)O)ₘ—(CF₂)ₙ—X³ (2)

wherein “m” is 0 or an integer of 1 to 5; “n” is an integer of 1 to 3; X³ is a cyano group, a carboxyl group, an alkoxycarbonyl group or a bromine atom. These monomers can be used alone or can be used in an optional combination thereof. These iodine atom, bromine atom, cyano group, carboxyl group, and alkoxycarbonyl group can function as a cure site.

The perfluoroelastomers can be prepared by usual processes.

Examples of the perfluoroelastomer are perfluoro rubbers disclosed in WO 97/24381, JP61-57324B, JP4-81608B and JP5-13961B.

In the present invention, a composition comprising the above-mentioned fluoroelastomer and a thermoplastic fluorine-containing rubber can also be used.

The fluoroelastomer sealing material used in the present invention can be molded by using a composition comprising the above-mentioned fluoroelastomer, a crosslinking agent and a crosslinking aid.

The crosslinking agent may be optionally selected depending on a crosslinking system to be employed. With respect to the crosslinking system, any of polyamine crosslinking system, polyol crosslinking system, peroxide crosslinking system and imidazole crosslinking system can be adopted. In addition, triazine crosslinking system, oxazole crosslinking system and thiazole crosslinking system can be adopted. Among these crosslinking agents, those of imidazole crosslinking system, triazine crosslinking system, oxazole crosslinking system and thiazole crosslinking system are preferable, and those of imidazole crosslinking system, oxazole crosslinking system and thiazole crosslinking system are more preferable from the viewpoint of heat resistance of the sealing material and from the viewpoint that sticking strength is small and contamination and discoloration of a surface coming into contact with the sealing material are improved.

Examples of the crosslinking agent are, for instance, polyhydroxy compounds such as bisphenol AF, hydroquinone, bisphenol A and diaminobisphenol AF in the polyol crosslinking peroxides such as α,α′-bis(t-butylperoxy)diisopropylbenzene, 2,5-dimethyl-2,5-di(t-butylperoxy)hexane and dicumyl peroxide in the peroxide crosslinking system; and polyamine compounds such as hexamethylenediamine carbamate and N,N′-dicinnamylidene-1,6-hexamethylenediamine in the polyamine crosslinking system.

The composition for forming the fluoroelastomer sealing material used in the present invention may contain organotin compound such as tetraphenyltin or triphenyltin in the case of the fluoroelastomer having cyano group since when the organotin compound is contained, the cyano group forms a triazine ring, thereby enabling triazine crosslinking.

Examples of a crosslinking agent used for oxazole crosslinking system, imidazole crosslinking system or thiazole crosslinking system are a bisaminothiophenol crosslinking agent, a bisaminophenol crosslinking agent and a bisdiaminophenyl crosslinking agent represented by the general formula (3):

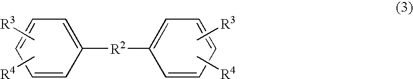

wherein R² is —SO₂—, —O—, —CO—, an alkylene group having 1 to 6 carbon atoms, a perfluoroalkylene group having 1 to 10 carbon atoms or a single bond, either R³ or R⁴ is —NH₂ and other one is —NHR⁵, —NH₂, —OH or —SH, R⁵ is hydrogen atom, a fluorine atom or a monovalent organic group, and preferably R³ is —NH₂ and R⁴ is —NHR⁵,
a bisamidrazone crosslinking agent represented by the general formula (4):

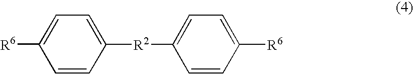

wherein R² is as defined above, R⁶ is

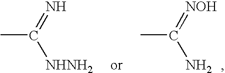

and bisamidoxime crosslinking agents represented by the general formulas (5) and (6):

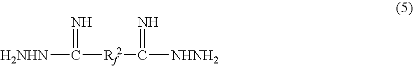

wherein R_{f}² is a perfluoroalkylene group having 1 to 10 carbon atoms, and

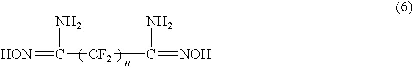

wherein n is an integer of 1 to 10. These bisaminophenol crosslinking agent, bisaminothiophenol crosslinking agent and bisdiaminophenyl crosslinking agent are crosslinking agents which have been used for crosslinking systems using a cyano group as a cure site and also react with a carboxyl group or an alkoxycarbonyl group to form an oxazole ring, a thiazole ring or an imidazole ring and give a crosslinked article.

Especially preferable crosslinking agents are compounds having a plurality of 3-amino-4-hydroxyphenyl groups or 3-amino-4-mercaptophenyl groups or compounds represented by the general formula (7):

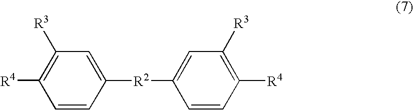

wherein R², R³ and R⁴ are as defined above, and there are concretely exemplified 2,2-bis(3-amino-4-hydroxyphenyl)hexafluoropropane (generally called bis(aminophenol)AF), 2,2-bis(3-amino-4-mercaptophenyl)hexafluoropropane, tetraaminobenzene, bis(3,4-diaminophenyl)methane, bis(3,4-diaminophenyl)ether, 2,2-bis(3,4-diaminophenyl)hexafluoropropane, and 2,2-bis[3-amino-4-(N-phenylamino)phenyl]hexafluoropropane.

The amount of crosslinking agent and/or organotin compound is preferably 0.01 to 10 parts by weight, more preferably 0.1 to 5 parts by weight based on 100 parts by weight of the fluoroelastomer. When the amount of crosslinking agent and/or organotin compound is less than 0.01 part by weight, performance of a molded article tends to be impaired because a degree of crosslinking becomes insufficient. When the amount exceeds 10 parts by weight, there is a tendency that it results in a longer crosslinking time and in addition, it is not preferable from economical point of view because a degree of crosslinking becomes too high.

In polyol crosslinking system, various organic bases used in usual crosslinking of elastomers such as various quaternary ammonium salts, quaternary phosphonium salts, cyclic amines and mono-functional amine compounds can be used as a crosslinking aid. Examples thereof are, for instance, quaternary ammonium salts such as tetrabutylammonium bromide, tetrabutylammonium chloride, benzyltributylammonium chloride, benzyltriethylammonium chloride, tetrabutylammonium hydrogen sulfate and tetrabutylammonium hydroxide; quaternary phosphonium salts such as benzyltriphenylphosphonium chloride, tributylallylphosphonium chloride, tributyl-2-methoxypropylphosphonium chloride and benzylphenyl(dimethylamino)phosphonium chloride; mono-functional amines such as benzylmethylamine and benzylethanolamine; and cyclic amines such as 1,8-diazabicyclo[5.4.0]-undec-7-ene.

Examples of a crosslinking aid for a peroxide crosslinking system are triallyl cyanurate, triallyl isocyanurate (TAIC), tris(diallylamine-s-triazine), triallyl phosphite, N,N-diallylacrylamide, hexaallylphosphoramide, N,N,N′,N′-tetraallyltetraphthalamide, N,N,N′,N′-tetraallylmalonamide, trivinyl isocyanurate, 2,4,6-trivinylmethyltrisiloxane, and tri(5-norbornene-2-methylene)cyanurate. Among these, triallyl isocyanurate (TAIC) is preferable from the viewpoint of crosslinkability and physical properties of a crosslinked article.

The amount of crosslinking aid is preferably 0.01 to 10 parts by weight, more preferably 0.1 to 5.0 parts by weight based on 100 parts by weight of the fluoroelastomer. When the amount of crosslinking aid is less than 0.01 part by weight, time for crosslinking tends to be extended to an extent not to be practicable. When the amount exceeds 10 parts by weight, there is a tendency that time for crosslinking becomes too short and in addition, compression set of a molded article is lowered.

Further, fillers (inorganic fillers such as carbon black, organic fillers such as polyimide resin powder), processing aid, pigment, metallic oxide such as magnesium oxide and metallic hydroxide such as calcium hydroxide which are usual additives may be used unless the object of the present invention is impaired.

Further, from the viewpoint of strength, hardness and sealing property, it is preferable to add fillers such as inorganic fillers such as carbon black and metallic oxide and organic fillers such as engineering resin powder. Examples of metallic oxide are aluminum oxide and magnesium oxide, and examples of organic fillers are imide fillers having imide structure such as polyimide, polyamide imide and polyetherimide; polyarylate, polysulfone, polyether sulfone, polyphenylene sulfide, polyether ether ketone and polyoxybenzoate.

The amount of these fillers is preferably 1 to 50 parts by weight, more preferably 5 to 20 parts by weight based on 100 parts by weight of the fluoroelastomer. When the amount of the fillers is less than 1 part by weight, there is a tendency that an effect of the filler is hardly expectable, and when the amount exceeds 50 parts by weight, there is a tendency that the sealing material becomes very hard and is not suitable as a sealing material.

Also, a processing aid, pigment and metallic hydroxide such as calcium hydroxide may be used unless the object of the present invention is impaired.

In addition, from the viewpoint of sealing property, it is preferable to select an optimum hardness of the sealing material itself depending on kind and thickness of the coating film.

A method of molding the fluoroelastomer sealing material is not limited particularly as far as it is a general molding method. For example, known methods such as compression molding, extrusion molding, transfer molding and injection molding can be adopted.

The sealing material of the present invention can be prepared by coating of the coating film prepared from an inorganic material all over the surface or a part of the surface of the fluoroelastomer sealing material, wherein a ratio of weight reduction of the sealing material after dipping it in perfluoro tri-n-butylamine at 60° C. for 70 hours and then taking it out and drying it at 90° C. for 5 hours, at 125° C. for 5 hours, and then at 200° C. for 10 hours, is not more than 0.4% by weight, or an amount of water generation from the fluoroelastomer sealing material by heating is not more than 400 ppm.

The inorganic material is at least one selected from the group consisting of metal, metallic oxide, metallic nitride, metallic carbonate, complex thereof and diamond-like carbon.

Examples of metal are aluminum, silicon, titanium, yttrium, and oxides, nitrides and carbonates thereof. Among these, aluminum and alumina are preferable from the viewpoint of material price, easiness of handling and plasma resistance.

Diamond-like carbon film is called diamond-like carbon (hereinafter referred to as DLC), and means a carbon film having a structure of diamond, in which carbons are bonded by sp³ hybrid orbital.

With respect to the coating film formed by using an inorganic material, proper film hardness can be selected depending on kind of the film. For example, in the case of diamond-like carbon film, its Vickers hardness is preferably 5 to 500, more preferably 20 to 150. When the Vickers hardness is less than 5, plasma resistance and non-sticking property tend to be inferior, and when it exceeds 500, sealing property tends to be inferior.

The thickness of the coating film formed by using an inorganic material can be properly selected depending on kind of the film. For example, in the case of diamond-like carbon film, its coating film thickness is preferably 0.05 to 10 μm, more preferably 0.1 to 5 μm. When the coating film thickness is less than 0.05 μm, there is a tendency that durability of the coating film itself is inferior and its characteristics such as non-sticking property and plasma resistance are not sufficient. When the coating film thickness exceeds 10 μm, since the coating film cannot follow deformation of the fluoroelastomer sealing material, there is a tendency that sealing property becomes inferior and cracking as lowering plasma resistance occurs on its surface. On the other hand, in the case of the coating film formed by using metal, metal oxide, metal nitride, metal carbonate or a complex thereof, the coating film thickness is preferably 0.005 to 1 μm, more preferably 0.01 to 0.8 μm. When the coating film thickness is less than 0.005 μm, there is a tendency that durability of the coating film itself is inferior and its characteristics such as non-sticking property and plasma resistance are not sufficient. When the coating film thickness exceeds 1 μm, since the coating film cannot follow deformation of the fluoroelastomer sealing material, there is a tendency that sealing property becomes inferior and cracking as lowering plasma resistance occurs on its surface.

For forming a coating film by using an inorganic material, a vacuum film forming method is suitably used. Examples of the vacuum film forming method are ion plating method, sputtering method, CVD method and vapor deposition method. Among these, plasma CVD method and ion plating method are preferable. Especially for forming a metal coating film, ion plating method is preferable from the viewpoint of adhesion of the coating film and from the point that the film can be formed at low temperature, evaporative material for coating is easily available and films of nitrides and carbonates can be formed. Among these, ion plating method using hollow cathode plasma gun is more preferable.

Film forming conditions in the ion plating method may be optionally selected depending on kind of a fluoroelastomer, kind of a coating film and a target film thickness, and are not limited particularly.

In addition, it is preferable to subject the surface of the fluoroelastomer sealing material to surface treatment by plasma ashing or the like before coating, from the viewpoint of improving adhesion of the coating layer.

Also, in the case where the coating film formed by using an inorganic material is a film of diamond-like carbon, a plasma CVD method is preferable for forming it, and for example, the method described in JP10-53870A can also be used suitably.

Further, a plurality of coating films formed by using an inorganic material can be used.

In the sealing material of the present invention, the ratio of weight reduction in the case of irradiation with O₂, CF₄ or NF₃ plasma under the following conditions is preferably not more than 1% by weight, more preferably not more than 0.1% by weight. As the ratio of weight reduction increases, there is a tendency that most of a plasma-shielding effect by the coating film is lost.

Sample: 2 mm thick, 10 mm×35 mm sheet

### Irradiation Conditions:

### O₂ and CF₄ Plasma

Gas flow: 16 SCCM

Pressure: 20 mTorr

Output: 800 W

Irradiation time: 10 minutes

### NF₃ Plasma

NF₃/Ar: 1 SLM/1 SLM

Pressure: 3 Torr

Irradiation time: 2 hours

Temperature: 150° C.

The sealing material of the present invention can be suitably used in the fields such as semiconductor-related fields such as semiconductor manufacturing equipment, liquid crystal panel manufacturing apparatuses, plasma panel manufacturing apparatuses, plasma addressed liquid crystal panels, field-emission display panels, and solar cell boards, and the fields of automobile, aircraft, rocket, marine vessel, chemical product plants, medicals such as pharmaceuticals, photograph such as developing machine, printing such as printing machine, painting such as painting equipment, analytical equipment, equipment in food plants, equipment in atomic power plants, iron and steel industry such as steel sheet processing equipment, general industry, electricity, fuel cells, and electronic parts.

Examples of sealing material used in the semiconductor-related fields such as semiconductor manufacturing equipment, liquid crystal panel manufacturing apparatuses, plasma panel manufacturing apparatuses, plasma addressed liquid crystal panels, field-emission display panels, and solar cell boards are O-(square-)ring, packing, tube, roll, coating, lining, gasket, diaphragm, hose, etc., and these can be used on CVD equipment, dry etching equipment, wet etching equipment, oxidation and diffusion equipment, sputtering equipment, ashing equipment, washing equipment, ion implantation equipment, exhausting equipment, chemicals piping and gas piping. Concretely, the sealing material can be used in the form of O-(square-)ring for an O-ring of gate valve, O-ring of quartz window, O-ring of chamber, O-ring of gate, O-ring of bell jar, O-ring of coupling, O-ring of pump, O-ring of gas control equipment for semiconductor (can be formed into a diaphragm), O-ring for resist developing solution and separating solution, and hose for wafer cleaning solution, and in the form of tube for a roll for transfer of wafer. In addition, the sealing material is used in the form of lining and coating such as lining of a resist developing solution tank and releasing solution tank, lining of a wafer washing solution tank and lining and coating of wet etching tank. Further, the sealing material is used as a sealing agent; coating material for quartz of optical fiber; potting, coating and adhesive seal of electronic parts and circuit board for the purpose of insulation, vibration-proof, water-proof and moisture-proof; gasket for magnetic storage; modifying material for a sealing material such as epoxy; sealant for clean room and cleaning equipment, etc.

The sealing material of the present invention can be suitably used as a sealing material especially for liquid crystal and semiconductor manufacturing equipment, particularly plasma treating equipment, from the viewpoint of excellent plasma resistance.

The present invention further relates to various parts having the sealing material of the present invention, especially parts for liquid crystal and semiconductor manufacturing equipment, particularly plasma treating equipment, from the viewpoint of excellent plasma resistance. Examples of the parts are the above-mentioned gate valve, quartz window, chamber, gate, bell jar, coupling and pump.

### EXAMPLES

The present invention is then explained by means of examples, but is not limited to such examples.

### Methods of Evaluation

### <Measurement of Ratio of Weight Reduction>

Measurement is carried out by:
(1) measuring a weight (Ag) of untreated (fluoroelastomer) sealing material,
(2) dipping the (fluoroelastomer) sealing material in perfluoro tri-n-butylamine at 60° C. for 70 hours and then taking out the molded article and drying it in an oven set at 90° C. for 5 hours, drying at a set temperature of the oven of 125° C. for 5 hours, and then drying at a set temperature of the oven of 200° C. for 10 hours,
(3) measuring a weight (Bg) of the dried (fluoroelastomer) sealing material. A ratio of weight reduction of the (fluoroelastomer) sealing material is calculated by {(A−B)/A}×100 (% by weight).

### <Amount of Water Generation>

An amount of water to be generated when heating O-rings (P24 size, 1.7 g) prepared in Examples and Comparative Examples at 200° C. for 30 minutes is measured with Karl Fischer water measuring equipment (AQS-720 available from Hiranuma Sangyo Corporation). The amount of water generation is a value (ppm) calculated by dividing an obtained actually measured water amount (μg) by a weight 1.7 g of the O-ring.

### <Non-Sticking Property>

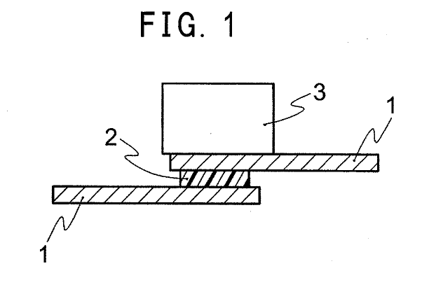

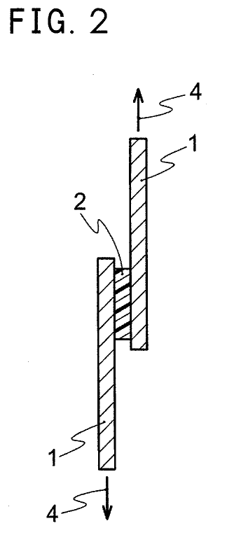

As shown in FIG. 1, O-ring (P24 size) as a test sample 2 obtained in Examples and Comparative Examples is placed between the two SUS316 sheets, and a weight 3 is placed thereon, followed by leaving it at 200° C. at 25% compression for 168 hours. Then, after cooling up to room temperature in a state that compression being kept applied, as shown in FIG. 2, the SUS316 sheets are stretched in shearing directions 4, and sticking strength (180 degrees, peeling by shearing) is measured.

### <Plasma Resistance>

Plasma resistance is measured under the following conditions by using O-rings (P24 size) obtained in Examples and Comparative Examples.

### (O₂, CF₄ Plasma)

Machine Used for Irradiation of Plasma: ICP High Density Plasma Equipment (Available from Kabushiki Kaisha Samco International Kenkyusho, Model RIE-101iPH)

### Conditions for Irradiation:

Gas flow . . . 16 SCCM

Pressure . . . 20 mTorr

Output . . . 800 W

Irradiation time . . . 10 minutes

Chamber temperature . . . 200° C.

Irradiation step: In order to stabilize an atmosphere in a chamber of plasma irradiation machine, actual gas discharging is carried out for 5 minutes for pre-treatment of the chamber without using a sample. Then, an aluminum vessel containing a test sample is placed at a center between the RF electrodes, and plasma is irradiated under the above-mentioned conditions. Measurement of weight: A weight of the sample is measured up to the place of 0.01 mg by using an electronic balance 2006 MPE available from Sertorious GMBH and then rounded to one decimal, and a weight reduction from a weight before the irradiation of plasma is indicated by % by weight.

### Preparation Example 1

Into a 3-liter stainless steel autoclave having no ignition source were introduced 1 liter of pure water, 10 g of an emulsifying agent:

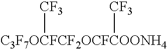

and 0.09 g of disodium hydrogen phosphate.12-water as a pH adjusting agent, and after sufficiently replacing the inside of a system with nitrogen gas and then deaerating, the autoclave was heated to 50° C. with stirring at 600 rpm, and a gas mixture of tetrafluoroethylene (TFE) and perfluoro(methyl vinyl ether) (PMVE) (TFE/PMVE=25/75 in mole ratio) was introduced so that the pressure inside the system became 0.78 MPa·G. Then, 10 ml of an aqueous solution of ammonium persulfate (APS) having a concentration of 527 mg/ml was introduced with pressurized nitrogen gas to initiate a reaction.

As polymerization proceeded, when the inside pressure decreased to 0.69 MPa·G, 3 g of CF₂═CFOCF₂CF(CF₃)OCF₂CF₂CN (CNVE) was introduced with pressurized nitrogen gas. Then, 4.7 g of TFE and 5.3 g of PMVE were introduced with their own pressures so that the inside pressure became 0.78 MPa·G. Thereafter, as the reaction proceeded, TFE and PMVE were introduced in the same manner as above and increasing and decreasing of pressure were repeated between 0.69 MPa·G and 0.78 MPa·G. In addition, every time the total amount of the introduced TFE and PMVE reached 70 g, 130 g, 190 g and 250 g, 3 g of CNVE was introduced with pressurized nitrogen gas.

19 hours after starting of the polymerization reaction, when the total introduced amount of TFE and PMVE reached 300 g, the autoclave was cooled, and unreacted monomers were discharged to obtain 1,330 g of an aqueous dispersion having a solid content of 21.2% by weight.

1,196 g of the obtained aqueous dispersion was diluted with 3,588 g of water, and slowly added to 2,800 g of a 3.5% by weight aqueous solution of hydrochloric acid with stirring. After stirring for five minutes after the addition, a coagulant was filtered off and the obtained polymer was poured into 2 kg of HCFC-141b, followed by stirring for five minutes and filtering off again. Thereafter, washing with HCFC-141b and filtering off were repeated four times, followed by vacuum-drying at 60° C. for 72 hours. Thus, 240 g of a polymer was obtained.

As a result of ¹⁹F-NMR analysis, this polymer was one comprising TFE/PMVE/CNVE in a percent by mole ratio of 56.6/42.3/1.1. According to measurement by infrared spectroscopic analysis, characteristic absorption of carboxyl group was recognized around 1,774.9 cm⁻¹ and 1,808.6 cm⁻¹, and characteristic absorption of OH group was recognized around 3,557.5 cm⁻¹ and 3,095.2 cm⁻¹.

### Preparation Example 2

Into a 6-liter stainless steel autoclave having no ignition source were introduced 2 liter of pure water, 20 g of C₇F₁₅COONH₄ as an emulsifying agent and 0.18 g of disodium hydrogen phosphate.12-water as a pH adjusting agent, and after sufficiently replacing the inside of a system with nitrogen gas and then deaerating, the autoclave was heated to 80° C. with stirring at 600 rpm, and a gas mixture of tetrafluoroethylene (TFE) and perfluoro(methyl vinyl ether) (PMVE) (TFE/PMVE=29/71 in mole ratio) was introduced so that the pressure inside the system became 1.17 MPa·G. Then, 2 ml of an aqueous solution of ammonium persulfate (APS) having a concentration of 186 mg/ml was introduced with pressurized nitrogen gas to initiate a reaction.

As polymerization proceeded, when the inside pressure decreased to 1.08 MPa·G, 4 g of pressurized I(CF₂)₄I was introduced. Then, 22.0 g of TFE and 20.0 g of PMVE were introduced with their own pressures, and increasing and decreasing of pressure were repeated. Every time the total amount of the introduced TFE and PMVE reached 430 g, 511 g, 596 g and 697 g, 1.5 g of pressurized ICH₂CF₂CF₂OCF═CF₂ was introduced. In addition, 2 ml of an aqueous solution of APS having a concentration of 20 mg/ml was introduced with pressurized nitrogen gas every 12 hours after starting of the reaction.

45 hours after starting of the polymerization reaction, when the total introduced amount of TFE and PMVE reached 860 g, the autoclave was cooled, and unreacted monomers were discharged to obtain an aqueous dispersion having a solid content of 30.0% by weight.

This aqueous dispersion was poured into a beaker, and frozen in dry ice/methanol for coagulation. After thawing, a coagulant was washed with water and vacuum-dried to obtain 850 g of a rubber-like polymer. A Mooney viscosity ML(1+10)(100° C.) of this polymer was 55.

As a result of ¹⁹F-NMR analysis, this polymer was one comprising TFE/PMVE in a percent by mole ratio of 64.0/36.0. Iodine content obtained by elemental analysis was 0.34% by weight.

### Preparation Example 3

A crosslinkable fluorine-containing rubber composition was prepared by mixing the cyano group-containing fluorine-containing elastomer having carboxyl group at its end and obtained in Preparation Example 1, 2,2-bis[3-amino-4-(N-phenylamino)phenyl)hexafluoropropane (AFTA-Ph) as a crosslinking agent synthesized by the process described in Journal of Polymer Science, Polymer Chemistry, Vol. 20, pp. 2,381 to 2,393 (1982), and carbon black (Thermax N-990 available from Cancarb Co., Ltd.) as a filler in a weight ratio of 100/2.83/20 and then kneading with an open roll.

This fluorine-containing rubber composition was crosslinked by pressing at 180° C. for 30 minutes, and then was subjected to crosslinking in an oven at 290° C. for 18 hours to prepare O-rings (A) of P24 size and AS035 size. A weight reduction ratio of a sample of O-ring (A′) prepared in the same manner as above was 0.80% by weight.

After dipped in R-318 (available from Daikin Industries, Ltd., principal component: C₈F₈Cl₁₂) at 60° C. for 70 hours, the O-ring (A) was dried at 90° C. for 5 hours, at 125° C. for 5 hours, and then at 200° C. for 10 hours to prepare an O-ring (B). A weight reduction ratio of a sample of O-ring (B′) prepared in the same manner as above was 0.06% by weight.

### Preparation Example 4

A crosslinkable fluorine-containing rubber composition was prepared by mixing the fluoroelastomer obtained in Preparation Example 2, triallyl isocyanurate (TAIC available from Nippon Kasei Chemical Co., Ltd.) and 2,5-dimethyl-2,5-bis(t-butylperoxy)hexane (PERHEXA 25B available from NOF CORPORATION) as crosslinking agents, and carbon black (Thermax N-990 available from Cancarb Co., Ltd.) as a filler in a weight ratio of 100/2/1/20 and then kneading with an open roll.

This fluorine-containing rubber composition was crosslinked by pressing at 160° C. for 10 minutes, and then was subjected to crosslinking in an oven at 180° C. for 4 hours to prepare O-rings (C) of P24 size and AS035 size. An amount of water generation by heating of a sample of O-ring (C′) prepared in the same manner as above was 460 ppm.

The O-ring (C) was washed with stirring in a sufficiently large amount of sulfuric acid/hydrogen peroxide (6/4 in a weight ratio) at 100° C. for 15 minutes, followed by washing with 5% hydrofluoric acid at 25° C. for 15 minutes, and then washing with boiling ultra-pure water at 100° C. for 2 hours. Then the O-ring was heat-treated at 200° C. for 18 hours in a nitrogen gas stream to prepare an O-ring (D). An amount of water generation by heating of a sample of O-ring (D′) prepared in the same manner as above was 200 ppm.

### Preparation Example 5

After dipped in FLORINATE FC-77 (available from Sumitomo 3M Limited) at 60° C. for 70 hours, the O-ring (A) was dried at 90° C. for 5 hours, at 125° C. for 5 hours, and then at 200° C. for 10 hours to prepare an O-ring (E). A weight reduction ratio of a sample of O-ring (E′) prepared in the same manner as above was 0.12% by weight.

### Example 1

A film of diamond-like carbon having Vickers hardness of 50 and an average film thickness of 0.1 μm was formed all over the surface of the O-ring (B) by plasma CVD method to prepare a sealing material (1). Tests for sealing property, plasma resistance and non-sticking property of the obtained sealing material (1) were conducted. The results are shown in Table 1. Also, a weight reduction ratio of the obtained sealing material (1) was 0.06% by weight.

### Example 2

A film of diamond-like carbon having Vickers hardness of 150 and an average film thickness of 0.1 μm was formed all over the surface of the O-ring (B) by plasma CVD method to prepare a sealing material (2). Tests for sealing property, plasma resistance and non-sticking property of the obtained sealing material (2) were conducted. The results are shown in Table 1. Also, a weight reduction ratio of the obtained sealing material (2) was 0.06% by weight.

### Example 3

An aluminum film having Vickers hardness of 2,000 and an average film thickness of 0.2 μm was formed all over the surface of the O-ring (D) by ion plating method (film forming conditions: evaporative material: aluminum, discharge current: 50 A, argon flow: 40 SCCM, film forming pressure: 0.25 mTorr) to prepare a sealing material (3). Tests for sealing property, plasma resistance and non-sticking property of the obtained sealing material (3) were conducted. The results are shown in Table 1. Also, an amount of water generation by heating of the obtained sealing material (3) was 200 ppm.

### Example 4

A sealing material (6) was prepared in the same manner as in Example 1 except that the O-ring (B) was changed to the O-ring (E). Tests for plasma resistance and non-sticking property of the obtained sealing material (6) were conducted. The results are shown in Table 1. Also, a weight reduction ratio of the obtained sealing material (6) was 0.12% by weight.

### Comparative Example 1

A sealing material (4) was prepared in the same manner as in Example 1 except that the O-ring (B) was changed to the O-ring (A). Tests for sealing property, plasma resistance and non-sticking property of the obtained sealing material (4) were conducted. The results are shown in Table 1. Also, a weight reduction ratio of the obtained sealing material (4) was 0.80% by weight.

### Comparative Example 2

A sealing material was prepared in the same manner as in Example 1 except that the O-ring (B) was changed to the O-ring (C). Tests for sealing property, plasma resistance and non-sticking property of the obtained sealing material (5) were conducted. The results are shown in Table 1. Also, an amount of water generation by heating of the obtained sealing material (5) was 460 ppm.

### Comparative examples 3 to 6

Tests for sealing property, plasma resistance and non-sticking property were conducted by using the O-ring (A), O-ring (B), O-ring (C) and O-ring (D) as they were without forming a coating film in Comparative Example 3, Comparative Example 4, Comparative Example 5, and Comparative Example 6, respectively. The results are shown in Table 1.

### Comparative Example 7

In Comparative Example 7, tests for plasma resistance and non-sticking property were conducted by using the O-ring (E) as it was without forming a coating film. The results are shown in Table 1.

TABLE 1

| | |
|---|---|
| Plasma resistance | Non-sticking |
| Weight reduction | property |
| ratio (% by weight) | Sticking |

| | O₂ | O₂/CF₄ | strength (kgf) |
|---|---|---|---|
| Ex. 1 | 0.44 | 0.67 | 0 |
| Ex. 2 | 0.21 | 0.25 | 0 |
| Ex. 3 | 0.01 | 0.01 | 0 |
| Ex. 4 | 0.48 | 0.66 | 0 |
| Com. Ex. 1 | 0.99 | 1.36 | 2.0 |
| Com. Ex. 2 | 0.82 | 1.24 | 1.0 |
| Com. Ex. 3 | 2.34 | 1.65 | 15.5 |
| Com. Ex. 4 | 2.33 | 1.66 | 5.8 |
| Com. Ex. 5 | 2.40 | 1.76 | 6.2 |
| Com. Ex. 6 | 2.42 | 1.72 | 6.2 |
| Com. Ex. 7 | 2.38 | 1.70 | 6.1 |

### Preparation Example 6

A crosslinkable fluorine-containing rubber composition was prepared by mixing the fluoroelastomer obtained in Preparation Example 2, triallyl isocyanurate (TAIC available from Nippon Kasei Chemical Co., Ltd.) and 2,5-dimethyl-2,5-bis(t-butylperoxy)hexane (PERHEXA 25B available from NOF CORPORATION) as crosslinking agents, and aluminum oxide (AKP-G015 available from Sumitomo Chemical Industry Co., Ltd.) as a filler in a weight ratio of 100/2/1/15 and then kneading with an open roll.

This fluorine-containing rubber composition was crosslinked by pressing at 160° C. for 10 minutes, and then was subjected to crosslinking in an oven at 180° C. for 4 hours to prepare O-rings (F) of P24 size and AS035 size. An amount of water generation by heating of a sample of O-ring (F′) prepared in the same manner as above was 280 ppm.

### Preparation Example 7

A crosslinkable fluorine-containing rubber composition was prepared in the same manner as in Preparation Example 6 except that a weight ratio was changed to 100/2/1/20.

This fluorine-containing rubber composition was crosslinked by pressing at 160° C. for 10 minutes, and then was subjected to crosslinking in an oven at 180° C. for 4 hours to prepare O-rings (G) of P24 size and AS035 size. An amount of water generation by heating of a sample of O-ring (G′) prepared in the same manner as above was 330 ppm.

### Preparation Example 8

A crosslinkable fluorine-containing rubber composition was prepared in the same manner as in Preparation Example 6 except that a weight ratio was changed to 100/2/1/22.5.

This fluorine-containing rubber composition was crosslinked by pressing at 160° C. for 10 minutes, and then was subjected to crosslinking in an oven at 180° C. for 4 hours to prepare O-rings (H) of P24 size and AS035 size. An amount of water generation by heating of a sample of O-ring (H′) prepared in the same manner as above was 370 ppm.

### Preparation Example 9

A crosslinkable fluorine-containing rubber composition was prepared in the same manner as in Preparation Example 6 except that a weight ratio was changed to 100/2/1/25.

This fluorine-containing rubber composition was crosslinked by pressing at 160° C. for 10 minutes, and then was subjected to crosslinking in an oven at 180° C. for 4 hours to prepare O-rings (I) of P24 size and AS035 size. An amount of water generation by heating of a sample of O-ring (I′) prepared in the same manner as above was 420 ppm.

### Preparation Example 10

A crosslinkable fluorine-containing rubber composition was prepared in the same manner as in Preparation Example 6 except that a weight ratio was changed to 100/2/1/30.

This fluorine-containing rubber composition was crosslinked by pressing at 160° C. for 10 minutes, and then was subjected to crosslinking in an oven at 180° C. for 4 hours to prepare O-rings (J) of P24 size and AS035 size. An amount of water generation by heating of a sample of O-ring (J′) prepared in the same manner as above was 510 ppm.

### Example 5

A film of diamond-like carbon having Vickers hardness of 50 and an average film thickness of 0.1 μm was formed all over the surface of the O-ring (F) by plasma CVD method to prepare a sealing material (7). Pin hole resistance of the obtained sealing material (7) was evaluated by the following method. The results are shown in Table 2. Also, an amount of water generation by heating of the obtained sealing material (7) was 280 ppm.

### <Pin Hole Resistance>

The O-rings (P24 size) obtained in Examples 5 to 7 and Comparative Examples 8 and 9 are subjected to irradiation with O₂ plasma, and the surfaces of the samples after the plasma irradiation are observed with a digital microscope (VH-6300 available from KEYENCE CORPORATION) to evaluate whether or not pin holes are generated.

### Criteria for Evaluation

⊚: No pin hole is generated on a surface of a sample 20 minutes after starting of the plasma irradiation.
◯: No pin hole is generated on a surface of a sample 10 minutes after starting of the plasma irradiation, but pin hole is generated 20 minutes after starting of the plasma irradiation.

X: Pin hole is generated on a surface of a sample 10 minutes after starting of the plasma irradiation.

### (O₂ Plasma)

Plasma irradiation machine to be used: ICP high density plasma equipment (available from Kabushiki Kaisha Samco International Kenkyusho, Model RIE-101iPH)

### Irradiation Conditions:

Gas flow . . . 16 SCCM

Pressure . . . 20 mTorr

Output . . . 800 W

Irradiation time . . . 10 minutes, 20 minutes

Chamber temperature . . . 200° C.

### Example 6

A film of diamond-like carbon having Vickers hardness of 50 and an average film thickness of 0.1 μm was formed all over the surface of the O-ring (G) by plasma CVD method to prepare a sealing material (8). Pin hole resistance of the obtained sealing material (8) was evaluated. The results are shown in Table 2. Also, an amount of water generation by heating of the obtained sealing material (8) was 330 ppm.

### Example 7

A film of diamond-like carbon having Vickers hardness of 50 and an average film thickness of 0.1 μm was formed all over the surface of the O-ring (H) by plasma CVD method to prepare a sealing material (9). Pin hole resistance of the obtained sealing material (9) was evaluated. The results are shown in Table 2. Also, an amount of water generation by heating of the obtained sealing material (9) was 370 ppm.

### Comparative Example 8

A film of diamond-like carbon having Vickers hardness of 50 and an average film thickness of 0.1 μm was formed all over the surface of the O-ring (I) by plasma CVD method to prepare a sealing material (10). Pin hole resistance of the obtained sealing material (10) was evaluated. The results are shown in Table 2. Also, an amount of water generation by heating of the obtained sealing material (10) was 420 ppm.

### Comparative Example 9

A film of diamond-like carbon having Vickers hardness of 50 and an average film thickness of 0.1 μm was formed all over the surface of the O-ring (J) by plasma CVD method to prepare a sealing material (11). Pin hole resistance of the obtained sealing material (11) was evaluated. The results are shown in Table 2. Also, an amount of water generation by heating of the obtained sealing material (11) was 510 ppm.

TABLE 2

| | | | | | Com. |
|---|---|---|---|---|---|
| | Ex. 5 | Ex. 6 | Ex. 7 | Com. Ex. 8 | Ex. 9 |
| Amount of water generation | 280 | 330 | 370 | 420 | 510 |
| after heating at 200° C. for 30 | | | | | |
| minutes (ppm) | | | | | |
| Pin hole resistance | ⊚ | ⊚ | ◯ | X | X |

### Preparation Example 11

After dipped in R-318 (available from Daikin Industries, Ltd., principal component: C₈F₈Cl₁₂) at 60° C. for 10 hours, the O-ring (A) prepared in Preparation Example 3 was dried at 90° C. for 5 hours, at 125° C. for 5 hours, and then at 200° C. for 10 hours to prepare an O-ring (K). A weight reduction ratio of a sample of O-ring (K′) prepared in the same manner as above was 0.48% by weight.

### Preparation Example 12

After dipped in R-318 (available from Daikin Industries, Ltd., principal component: C₈F₈Cl₁₂) at 60° C. for 20 hours, the O-ring (A) prepared in Preparation Example 3 was dried at 90° C. for 5 hours, at 125° C. for 5 hours, and then at 200° C. for 10 hours to prepare an O-ring (L). A weight reduction ratio of a sample of O-ring (L′) prepared in the same manner as above was 0.36% by weight.

### Preparation Example 13

After dipped in R-318 (available from Daikin Industries, Ltd., principal component: C₈F₈Cl₁₂) at 60° C. for 30 hours, the O-ring (A) prepared in Preparation Example 3 was dried at 90° C. for 5 hours, at 125° C. for 5 hours, and then at 200° C. for 10 hours to prepare an O-ring (M). A weight reduction ratio of a sample of O-ring (M′) prepared in the same manner as above was 0.20% by weight.

### Preparation Example 14

After dipped in R-318 (available from Daikin Industries, Ltd., principal component: C₈F₈Cl₁₂) at 60° C. for 50 hours, the O-ring (A) prepared in Preparation Example 3 was dried at 90° C. for 5 hours, at 125° C. for 5 hours, and then at 200° C. for 10 hours to prepare an O-ring (N). A weight reduction ratio of a sample of O-ring (N′) prepared in the same manner as above was 0.10% by weight.

### Comparative Example 10

A film of diamond-like carbon having Vickers hardness of 50 and an average film thickness of 0.1 μm was formed all over the surface of the O-ring (K) by plasma CVD method to prepare a sealing material (12). Pin hole resistance of the obtained sealing material (12) was evaluated. The results are shown in Table 3. A weight reduction ratio of the obtained sealing material (12) was 0.48% by weight.

### Example 8

A film of diamond-like carbon having Vickers hardness of 50 and an average film thickness of 0.1 μm was formed all over the surface of the O-ring (L) by plasma CVD method to prepare a sealing material (13). Pin hole resistance of the obtained sealing material (13) was evaluated. The results are shown in Table 3. A weight reduction ratio of the obtained sealing material (13) was 0.36% by weight.

### Example 9

A film of diamond-like carbon having Vickers hardness of 50 and an average film thickness of 0.1 μm was formed all over the surface of the O-ring (M) by plasma CVD method to prepare a sealing material (14). Pin hole resistance of the obtained sealing material (14) was evaluated. The results are shown in Table 3. A weight reduction ratio of the obtained sealing material (14) was 0.20% by weight.

### Example 10

A film of diamond-like carbon having Vickers hardness of 50 and an average film thickness of 0.1 μm was formed all over the surface of the O-ring (N) by plasma CVD method to prepare a sealing material (15). Pin hole resistance of the obtained sealing material (15) was evaluated. The results are shown in Table 3. A weight reduction ratio of the obtained sealing material (15) was 0.10% by weight.

TABLE 3

| | | | | Com. | Com. |
|---|---|---|---|---|---|
| | Ex. 8 | Ex. 9 | Ex. 10 | Ex. 3 | Ex. 10 |
| Weight reduction ratio after | 0.36 | 0.20 | 0.10 | 0.80 | 0.48 |
| dipping and heating at 60° C. | | | | | |
| and then drying at 90° C. for | | | | | |
| 5 min, at 125° C. for 5 hrs, | | | | | |
| and at 200° C. for 10 hrs (% | | | | | |
| by weight) | | | | | |
| Pin hole resistance | ◯ | ⊚ | ⊚ | X | X |

### INDUSTRIAL APPLICABILITY

The present invention can provide the sealing material having improved plasma resistance, sealing property and non-sticking property since it has the coating film formed by using inorganic material on the surface of the specific fluoroelastomer sealing material.

1. A sealing material comprising a fluoroelastomer sealing material and a coating film formed by using an inorganic material on the surface of the fluoroelastomer sealing material, wherein a ratio of weight reduction of the sealing material after dipping it in perfluoro tri-n-butylamine at 60° C. for 70 hours and then taking it out and drying it at 90° C. for 5 hours, at 125° C. for 5 hours, and then at 200° C. for 10 hours, is not more than 0.4% by weight.

2. A sealing material comprising a fluoroelastomer sealing material and a coating film formed by using an inorganic material on the surface of the fluoroelastomer sealing material, wherein an amount of water generation from the sealing material by heating is not more than 400 ppm.

3. The sealing material of claim 1, wherein the coating film formed by using an inorganic material is a film of diamond-like carbon.

4. The sealing material of any of claim 1, wherein the fluoroelastomer is a perfluoroelastomer.

5. The sealing material of any of claim 1, which is used on plasma treating equipment.

6. Parts for plasma treating equipment having the sealing material of claim 1.

7. A process for preparing a sealing material comprising forming a coating film by using an inorganic material on a surface of a fluoroelastomer sealing material, wherein a ratio of weight reduction of the fluoroelastomer sealing material after dipping it in perfluoro tri-n-butylamine at 60° C. for 70 hours and then taking it out and drying it at 90° C. for 5 hours, at 125° C. for 5 hours, and then at 200° C. for 10 hours, is not more than 0.4% by weight.

8. A process for preparing a sealing material comprising forming a coating film by using inorganic material on a surface of a fluoroelastomer sealing material, wherein an amount of water generation from the fluoroelastomer sealing material by heating is not more than 400 ppm.

9. The sealing material of claim 2, wherein the coating film formed by using an inorganic material is a film of diamond-like carbon.

10. The sealing material of claim 2, wherein the fluoroelastomer is a perfluoroelastomer.

11. The sealing material of claim 3, wherein the fluoroelastomer is a perfluoroelastomer.

12. The sealing material of claim 9, wherein the fluoroelastomer is a perfluoroelastomer.

13. The sealing material of claim 2, which is used on plasma treating equipment.

14. The sealing material of claim 3, which is used on plasma treating equipment.

15. The sealing material of claim 9, which is used on plasma treating equipment.

16. Parts for plasma treating equipment having the sealing material of claim 2.

17. Parts for plasma treating equipment having the sealing material of claim 3.

18. Parts for plasma treating equipment having the sealing material of claim 9.
